(19) United States
(12) Patent Application Publication
(10) Pub. No.: US 2010/0207945 A1
(43) Pub. Date: Aug. 19, 2010

(54) TEMPLATE FOR CREATING SEQUIN-BASED DESIGNS & METHODS OF USE THEREOF

(76) Inventor: Jeremy A. Kirsch, Glendale, CA (US)

Correspondence Address: Loza & Loza LLP, 305 North Second Ave., #127, Upland, CA, 91786, US

(21) Appl. No.: 12/699,067

(22) Filed: Feb. 3, 2010

Related U.S. Application Data
(60) Provisional application No. 61/152,698, filed on Feb. 14, 2009.

(51) Int. Cl. G06T 17/00; G01B 1/00; G09G 5/02

(52) U.S. Cl. 345/428; 33/562; 345/595

(57) ABSTRACT

Embodiments of the invention are directed to templates for creating sequin-based designs and methods of use thereof. In one embodiment, the template may be a first panel which includes a plurality of cylindrical protrusions uniformly spaced thereon. A second panel may be removably coupled to a backside of the first panel. Each cylindrical protrusion may include an opening capable of receiving a shaft of a pin. In one method, a plurality of sequins or paillettes may be removably attached to the plurality of cylindrical protrusion by insertion of each pin into an opening in the sequin followed by insertion of the pin shaft into the opening of the raised cylinder. A plurality of templates tiled together with a plurality of sequins attached thereto may result in a photographic sequin-based design.

### PRIORITY CLAIM

The present Utility Application for Patent claims priority to U.S. Provisional Application No. 61/152,698 entitled “TEMPLATE FOR CREATING SEQUIN-BASED DESIGNS & METHODS OF USE THEREOF” filed Feb. 14, 2009 which is hereby expressly incorporated by reference herein.

### FIELD OF INVENTION

At least one feature pertains to a template for creating sequin-based designs and methods of use thereof.

### BACKGROUND OF INVENTION

“Sequin signs” are signs or displays in which sequins are loosely mounted on a backing such that the sequins move and sparkle when subjected to a breeze, wind or an artificial means of air circulation such as a fan. A “sequin” is a small shining disk or spangle used for ornamentation on various mediums. A conventional sequin sign may be made of a backing with a plurality of pegs and a plurality of pins fixedly attached thereto. The plurality of pins may be pre-molded into the plurality of pegs such that there is a gap between each peg and a head of a pin. To create a sequin sign, a plurality of sequins, each with an oblong-shaped opening, is forced over the head of each pin. This design may subject the sequins to distortion, breakage or tears that may result in a waste of material (for sequins that need to be replaced) and/or a less than aesthetically-pleasing sequin sign.

Conventional sequin signs are typically comprised of large areas of single color and are meant to be viewed from a distance. Moreover, conventional sequin signs use large diameter sequins in a very limited range of colors. Additionally, sequins used in conventional sequin signs often incorporate a long slot for positioning the sequin on the pin. This long slot may cause the sequin to come off of the pin.

### SUMMARY OF INVENTION

A template for creating sequin-based designs, comprising: (i) a first panel having a plurality of protrusions uniformly spaced thereon, each protrusion extending in an outwardly direction relative to a face of the first panel, each protrusion tapering at a distal end thereof and terminating in a flat surface wherein the flat surface includes an opening sized to accommodate a shaft of a pin while simultaneously preventing a head of the pin from passing therethrough; and (ii) a second panel adapted to couple to a back surface of the first panel is herein disclosed.

In one embodiment, the first and second panels are square in configuration and have approximately the same area. In one embodiment, each protrusion is approximately cylindrical in configuration. Moreover, the plurality of protrusions may be arranged in an array of rows from a first edge of the first panel to a second opposing edge of the first panel. Moreover, each protrusion in each row may be identified by a sequential letter-number combination. In one embodiment, the opening is adapted to retain a paillette when a pin is engaged with the opening.

A system for creating a sequin-based design, comprising: (i) loading an image having a plurality of colors into image-editing software on a computer; (ii) reducing the image into a predetermined number of pixels, each pixel to correspond to a sequin; (iii) converting colors of the image to correspond to a restricted virtual color palette, the restricted virtual color palette corresponding to a plurality of different colored sequins; and (iv) producing at least one pattern based on the conversion is herein disclosed.

The system may further comprise: (v) scanning a plurality of sequins into the software wherein each sequin is separately scanned; and (vi) causing a color of each scanned sequin to be assigned to a restricted virtual color palette within the software. In one embodiment, each pattern comprises a plurality of squares comprising a sequentially numbered grid, each square of the grid corresponding to a pixel of the image, each pixel to correspond to a sequin. Moreover, each square on the grid may be filled with a color from the restricted virtual color palette. The system may further comprise: (vii) using the at least one template to create a predetermined sequin-based design. The design may be photographic in nature.

A backdrop for creating a sequin-based design, comprising: a plurality of templates tiled together, each template comprising: (i) a first panel having a plurality of protrusions uniformly spaced thereon, each protrusion extending in an outwardly direction relative to a face of the first panel, each protrusion tapering at a distal end thereof and terminating in a flat surface wherein the flat surface includes an opening sized to accommodate a shaft of a pin while simultaneously preventing a head of the pin from passing therethrough; and (ii) a second panel adapted to couple to a back surface of the first panel is herein disclosed.

In one embodiment, each template is based on a pattern. Each pattern may be creating by a process comprising (i) loading an image having a plurality of colors into image-editing software on a computer; (ii) reducing the image into a predetermined number of pixels, each pixel to correspond to a sequin; (iii) converting colors of the image to correspond to a restricted virtual color palette, the restricted virtual color palette corresponding to a plurality of different colored sequins; and (iv) producing the at least one pattern based on the conversion. In one embodiment, the process further comprises (v) scanning a plurality of sequins into the software wherein each sequin is separately scanned; and (vi) causing a color of each scanned sequin to be assigned to a restricted virtual color palette within the software. Each protrusion of each template may be approximately cylindrical in configuration. Moreover, the plurality of protrusions of each template may be arranged in an array of rows from a first edge of the first panel to a second opposing edge of the first panel. Moreover, each protrusion in each row in each template may be identified by a sequential letter-number combination. In one embodiment, each opening is adapted to retain a paillette when a pin is engaged with the opening.

A system for creating a sequin-based design, comprising: (i) threading a pin through a sequin having a predetermined aperture, the predetermined aperture sized to accommodate a shaft of a pin while simultaneously preventing a head of the pin from passing therethrough; (ii) inserting the pin into an opening of a cylindrical protrusion on a first panel, the opening sized to accommodate the shaft of the pin while simultaneously preventing the head of the pin from passing therethrough; and (iii) repeating the threading and the inserting to create a predetermined design is herein disclosed.

### BRIEF DESCRIPTION OF THE DRAWINGS

FIG. 1A illustrates a top perspective view of a template for creating sequin-based designs according to an embodiment of the invention.

FIG. 1B illustrates a partial bottom perspective view of the template of FIG. 1A.

### DETAILED DESCRIPTION

The following detailed description is of the best currently contemplated modes of carrying out the invention. The description is not to be taken in a limiting sense, but is made merely for the purpose of illustrating the general principles of the invention.

Embodiments of the invention are directed to templates for creating sequin-based designs and methods of use thereof. In one embodiment, the template may be a first panel which includes a plurality of cylindrical protrusions uniformly spaced thereon. A second panel may be removably coupled to a backside of the first panel. Each cylindrical protrusion may include an opening capable of receiving a shaft of a pin. In one method, a plurality of sequins or paillettes (hereinafter used interchangeably) may be removably attached to the plurality of cylindrical protrusion by insertion of each pin into an opening in the sequin followed by insertion of the pin shaft into the opening of the raised cylinder. A plurality of templates tiled together with a plurality of sequins attached thereto may result in a photographic sequin-based design. In the context of this application, “photographic” means pertaining to a photograph or suggestive of a photograph.

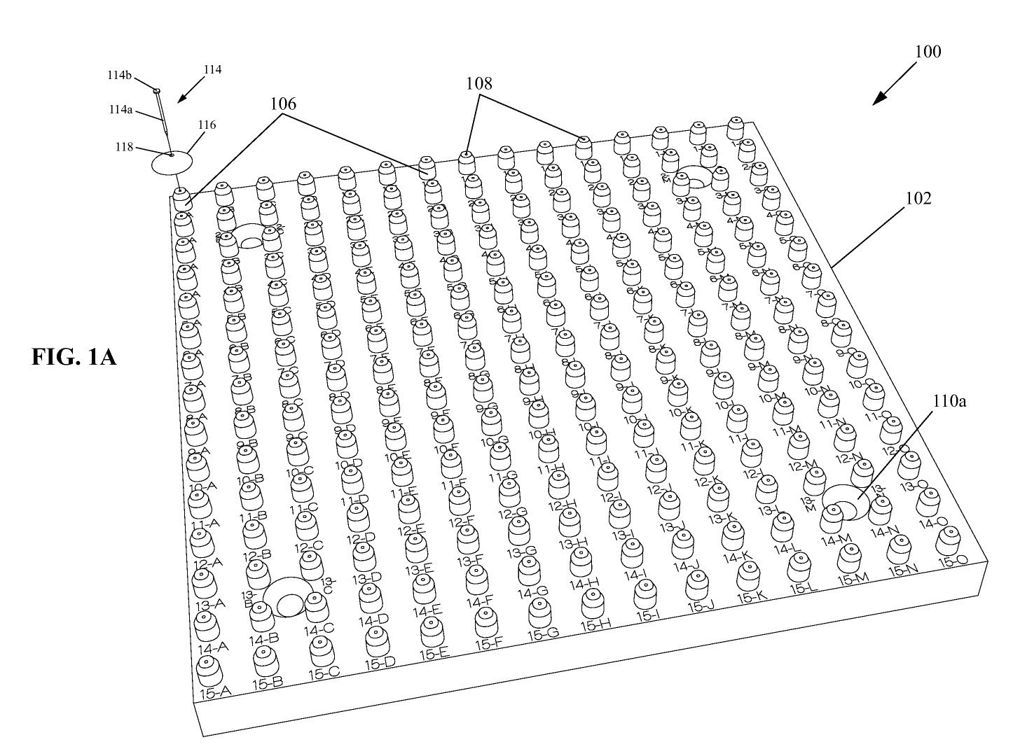

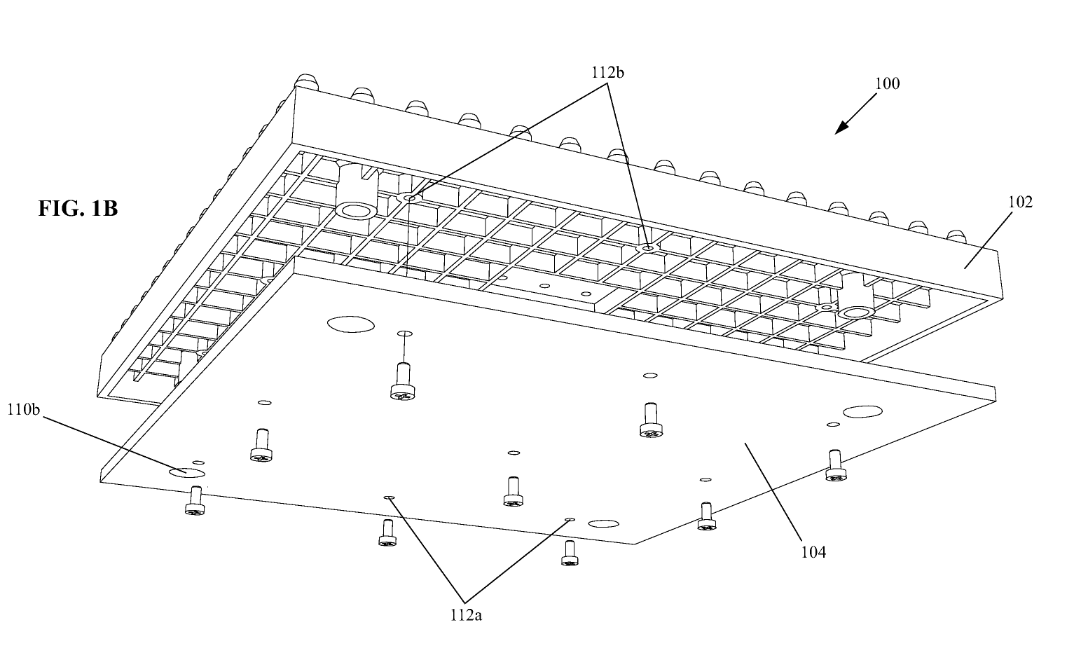

FIG. 1A illustrates a top perspective view of a template for creating sequin-based designs according to an embodiment of the invention. Template 100 may be comprised of a first panel 102 and a second panel 104 (see FIG. 1B) capable of coupling to a backside of first panel 102. Generally, first and second panels 102, 104 are approximately polygonal in configuration. In one embodiment, first and second panels 102, 104 are square; however, other geometric configurations are within the scope of the invention. In the embodiment in which first and second panels 102, 104 are square, first and second panels 102, 104 may have the same or approximately the same area. First and second panels 102, 104 may be approximately twelve (12) inches by twelve (12) inches, in one embodiment, approximately (6) inches by (6) inches. First panel 102 may be made of a pre-molded plastic material such as, but not limited to, acrylonitrile butadiene styrene (ABS). Second panel 104 may be laser-cut and may be made of durable polymer such as, but not limited to, acrylic. However, one of ordinary skill in the art would appreciate that first and second panels 102, 104 can be made of virtually any suitable material.

A face of first panel 102 may include a plurality of protrusions 106 uniformly spaced thereon. In some embodiments, the protrusions 106 are in an array of rows. The plurality of protrusions 106 may be approximately cylindrical, square or any other suitable configuration. Each cylindrical protrusion 106 includes an opening 108 therethrough and sized to accommodate a shaft of a pin yet narrow enough to prevent a head of the pin from passing therethrough (explained in more detail below). In one embodiment, each cylindrical protrusion 106 extends outwardly from the face of first panel 102, then tapers and terminates in a flat or substantially flat top surface. In one embodiment, the face of first panel 102 includes approximately two-hundred and twenty-five (225) cylindrical protrusions 106. Moreover, each cylindrical protrusion 106 may be identified by a letter-number combination, e.g., 1-A, 2-A through n-A; 1-B, 2-B through n-B, and so on and so forth.

The face of first panel 102 may include a plurality of depressed openings 110a sized to receive a plurality of screws (not shown). For example, in one embodiment, first panel 102 may include four (4) depressed openings 110a located approximate to each of the corners of first panel 102 (in the case in which panel 102 is square). A screw, such as those known by one of ordinary skill in the art, may be inserted into each depressed opening 110a to affix first panel 102 to a flat surface, such as a wall, a fence or any other suitable mounting platform. In addition to passing through each depressed opening 110a, each screw also passes through corresponding holes 110b of second panel 104 (see FIG. 1B).

FIG. 1B illustrates a partial bottom perspective view of the template of FIG. 1A. As shown in FIG. 1B, second panel 104 is illustrated with a plurality of openings 112a for coupling second panel 104 to the backside of first panel 102. Thus, according to this embodiment, first panel 102 includes a plurality of corresponding openings 112b for receiving a plurality of screws for coupling second panel 104 to the backside of first panel 102. Openings 112b do not completely pass through first panel 102. Thus, back panel 104 is not visible to the observer when template 100 is in use. In one aspect, second panel 104 functions as a “stopping point” for the plurality of pins, thereby ensuring that all pins are inserted to substantially or completely the same depth (explained in more detail below).

According to one embodiment of the invention, a sequin-based design, e.g., a sequin-mosaic or a sequin-sign, can be created using one or more templates 100 as described previously. For example, a pin 114 having a shaft 114a and a head 114b may be threaded through a predetermined aperture of a sequin 116 (see FIG. 1A). The predetermined aperture may be located within an inner circumference of the sequin 116. The aperture in the sequin may be sized such that the shaft of the pin may easily pass therethrough yet sized to prevent the head of the pin from simultaneously passing therethrough. The pin having the sequin thereon may then be inserted into a cylindrical protrusion 106. Second panel 104, which is coupled to first panel 102, functions as a “stopping point” for each pin, thereby ensuring that a plurality of pins are inserted to substantially or completely the same depth. Once the pins are inserted, there remains a small amount of space between the heads of the pins and the flat top surface of the cylindrical protrusions 106. This “wiggle room” allows each sequin to swing freely on the pin when subjected to a breeze, wind or an artificial means of air circulation. The process of threading a pin through a sequin and inserting it into a cylindrical protrusion 106 may be repeated until a predetermined sequin-based design is created. Multiple templates 100 may be tiled together to form a backdrop to create a sequin-based design of any size. In some embodiments, each template may correspond to a pattern generated by a computer-imaging technique (explained in more detail below).

Advantageously, embodiments of the invention such as template 100 are unique in that the pins are not pre-molded into the surface of first panel 102. By comparison, conventional backings for sequin-based designs include pre-molded pins thus requiring each sequin to be slotted so that they can fit over the heads of the pins. Conventional backings may therefore subject the sequins to distortion, breakage or tears that may result in a waste of material (for sequins that need to be replaced) and/or a less than aesthetically-pleasing sequin sign. Embodiments of the invention, however, such as template 100, allow for the use of sequins with a predetermined “round” hole instead of an elongated slot thereby completely or substantially preventing the disadvantages of conventional panels. As a result, embodiments of the invention allow for a cleaner, less-cluttered look relative to conventional backings. Furthermore, embodiments of the invention such as template 100 ensure that the sequins cannot slip off of their pins. By utilizing smaller-diameter sequins in a much wider range of colors, in combination with a special computer-imaging technique, embodiments of the invention allows for the creating of high-resolution, fully photographic sequin imagery. The resulting effect is anticipated to be more subtle and artistic and allows for use in higher-end applications.

In one embodiment, the computer-imaging technique allows the scanning or loading of an image or design to be created into image-editing software. The image is scaled down to a limited number of pixels wherein each pixel represents a single sequin. The colors of the image are then converted into a restricted color palette representing the actual available sequin colors. The resulting image file is then used to output a series of templates showing exactly where each sequin is to be placed.

More particularly, according to one embodiment, first, the actual sequins (one of each color) are scanned into a raster-based image-editing program (such as ADOBE PHOTOSHOP, or any other suitable software program). The colors captured by the scanner are assigned to a restricted, or “indexed color” palette within the software. Next, the image or design to be created is scanned or loaded into the same software, where it is scaled down to a limited number of pixels, with each individual pixel representing what will be a single sequin in the finished design. The custom restricted color palette (generated earlier) is then applied to the image, utilizing diffusion dithering in order to create the illusion of smooth color gradations within the image. Finally, the resulting image file is used to generate a series of templates (or patterns). Each pattern consists of a numbered grid, with each square of the grid corresponding to a single pixel of the image, and thus, to a single sequin. Squares on the grid are filled with various colors from the indexed color palette, showing the person assembling the design exactly where each individual sequin is to be placed.

While certain exemplary embodiments have been described and shown in the accompanying drawings, it is to be understood that such embodiments are merely illustrative of and not restrictive on the broad invention, and that this invention is not to be limited to the specific constructions and arrangements shown and described, since various other modifications may occur to those ordinarily skilled in the art.

What is claimed is:

1. A template for creating sequin-based designs, comprising:
a first panel having a plurality of protrusions uniformly spaced thereon, each protrusion extending in an outwardly direction relative to a face of the first panel, each protrusion tapering at a distal end thereof and terminating in a flat surface wherein the flat surface includes an opening sized to accommodate a shaft of a pin while simultaneously preventing a head of the pin from passing therethrough; and
a second panel adapted to couple to a back surface of the first panel.

2. The template of claim 1 wherein the first and second panels are square in configuration and have approximately the same area.

3. The template of claim 2 wherein each protrusion is approximately cylindrical in configuration.

4. The template of claim 3 wherein the plurality of protrusions are arranged in an array of rows from a first edge of the first panel to a second opposing edge of the first panel.

5. The template of claim 4 wherein each protrusion in each row is identified by a sequential letter-number combination.

6. The template of claim 1 wherein the opening is adapted to retain a paillette when a pin is engaged with the opening.

7. A system for creating a sequin-based design, comprising:
loading an image having a plurality of colors into image-editing software on a computer;
reducing the image into a predetermined number of pixels, each pixel to correspond to a sequin;
converting colors of the image to correspond to a restricted virtual color palette, the restricted virtual color palette corresponding to a plurality of different colored sequins; and
producing at least one pattern based on the conversion.

8. The system of claim 7, further comprising:
scanning a plurality of sequins into the software wherein each sequin is separately scanned; and
causing a color of each scanned sequin to be assigned to a restricted virtual color palette within the software.

9. The system of claim 8 wherein each pattern comprises a plurality of squares comprising a sequentially numbered grid, each square of the grid corresponding to a pixel of the image, each pixel to correspond to a sequin.

10. The system of claim 9 wherein each square on the grid is filled with a color from the restricted virtual color palette.

11. The system of claim 8, further comprising, using the at least one template to create a predetermined sequin-based design.

12. The system of claim 11 wherein the design is photographic.

13. A backdrop for creating a sequin-based design, comprising:
a plurality of templates tiled together, each template comprising:
a first panel having a plurality of protrusions uniformly spaced thereon, each protrusion extending in an outwardly direction relative to a face of the first panel, each protrusion tapering at a distal end thereof and terminating in a flat surface wherein the flat surface includes an opening sized to accommodate a shaft of a pin while simultaneously preventing a head of the pin from passing therethrough; and
a second panel adapted to couple to a back surface of the first panel.

14. The backdrop of claim 13 wherein each template is based on a pattern.

15. The backdrop of claim 14 wherein each pattern is creating by a process comprising:
loading an image having a plurality of colors into image-editing software on a computer;
reducing the image into a predetermined number of pixels, each pixel to correspond to a sequin;
converting colors of the image to correspond to a restricted virtual color palette, the restricted virtual color palette corresponding to a plurality of different colored sequins; and
producing the at least one pattern based on the conversion.

16. The backdrop of claim 15 wherein the process further comprises:
scanning a plurality of sequins into the software wherein each sequin is separately scanned; and
causing a color of each scanned sequin to be assigned to a restricted virtual color palette within the software.

17. The backdrop of claim 16 wherein each protrusion of each template is approximately cylindrical in configuration.

18. The backdrop of claim 17 wherein the plurality of protrusions of each template are arranged in an array of rows from a first edge of the first panel to a second opposing edge of the first panel.

19. The backdrop of claim 18 wherein each protrusion in each row in each template is identified by a sequential letter-number combination.

20. The backdrop of claim 19 wherein each opening is adapted to retain a paillette when a pin is engaged with the opening.
